(19) United States
(12) Patent Application Publication
(10) Pub. No.: US 2006/0171781 A1
(43) Pub. Date: Aug. 3, 2006

(54) Pipeline trench system and method of construction

(76) Inventors: Jon R. Bose, Bellville, TX (US); Orville D. Harris, Houston, TX (US); C. Lee Sherrod, Dripping Springs, TX (US); Allan W. Wolff, Austin, TX (US); James Beach, Austin, TX (US); Charles Kreitler, Austin, TX (US); Charles Meyer, Giddings, TX (US); William V. Murchison, Dallas, TX (US); Mike Swearingen, Pollok, TX (US); James Applegath, Houston, TX (US); Don Martin, Austin, TX (US); Trey Salinas, Austin, TX (US); Mark S. Gerding, Houston, TX (US); David C. Stewart, Tulsa, OK (US)

Correspondence Address: JENKENS & GILCHRIST, PC, 1445 ROSS AVENUE, SUITE 3200, DALLAS, TX, 75202, US

(21) Appl. No.: 10/703,861

(22) Filed: Nov. 6, 2003

Related U.S. Application Data
(60) Provisional application No. 60/424,674, filed on Nov. 7, 2002.

(51) Int. Cl. F16L 57/00

(52) U.S. Cl. 405/157

(57) ABSTRACT

A pipeline trench system may include a vault and a bore pit in select flow communication therewith for substantially containing fluid spilled from a pipeline disposed therein. An above-ground containment system may also be provided with or without an underlying bore pit. The vault may include side walls and a lower barrier, sealed together, with an upper barrier positioned thereover. The vault may be filled with bedding, backfill, and a pipeline running therethrough. The bore pit includes similar features to that of the vault with the exception that the bore pit is larger than the vault permitting the flow of released leakage to be contained therein. The above-ground containment system includes berms and diked areas for directing and/or containing select liquid flow.

### CROSS-REFERENCES TO RELATED APPLICATIONS

This application claims priority from, and incorporates by reference for any purpose the entire disclosure of, U.S. Provisional Patent Application No. 60/424,674 filed Nov. 7, 2002.

### BACKGROUND OF THE INVENTION

1. Field of the Invention

The present invention relates to pipeline trench systems, and more particularly, but not by way of limitation, to a pipeline trench system and method of construction utilizing a spill containment vault and surface berm system, in selective flow communication therewith, capable of containing fluid leaking from a pipe disposed within the trench for subsequent collection of leaking fluid therefrom.

2. History of Related Art

The public relations problems associated with pipelines constructed to carry hydrocarbons across any appreciable distance is well known to government, industry, and the general public. More significant concern arises when pipelines extend across environmentally sensitive and/or populated areas. It has been found that if a pipeline, carrying hydrocarbons or other liquids, develops a leak allowing seepage of the hydrocarbons or other liquids into the surrounding area, the environment may be adversely affected. For example, a pipeline leak, that is not appropriately contained, can result in surface flows or groundwater flows carrying the polluting hydrocarbons to an underground water supply. Not only is the water supply tainted, but wildlife associated with either the groundwater or underground water supply may suffer from effects caused by the release of the hydrocarbons.

The perceived environmental impact from a leak of hazardous liquids over a sensitive environmental area, such as an aquifer recharge region, may in some cases potentially be contamination of the aquifer. This could cause significant environmental impacts for the users of the aquifer, which may, in some cases, number in the hundreds of thousands of people in multiple cities and towns. For these reasons, modern improvements in pipeline reliability are not always “perceived as” or “deemed” sufficient. The present invention thus relates to a pipeline trench and above-ground containment system and method minimizing the exposure of the surrounding area to liquids such as hydrocarbons that may harm the environment.

### SUMMARY OF THE INVENTION

The present invention relates to pipeline trench systems and methods of construction. More particularly, one aspect of the invention includes a pipeline trench vault for housing a pipeline and containing leaks occurring from the pipeline disposed therein. The vault includes side walls formed of a substantially fluid impervious material, a lower barrier in engagement with the side walls. The lower barrier is formed of a substantially fluid impervious material. The sealed vault also includes a first bonding agent adapted for bonding the side walls to the lower barrier.

In another aspect, the present invention relates to an above-ground containment system for containing select fluids released from a pipeline containment trench. The above-ground containment system includes at least one berm for directing flow of the select fluids discharged from the pipeline containment trench, a containment area for collecting the fluids from the pipeline containment trench, a drainage pipe for allowing water in the containment area to pass to a surrounding area, and a select fluid sensing valve disposed in the drainage pipe for activating in the presence of select fluids and substantially preventing these fluids from passing therethrough. In one embodiment, the select fluids contain hydrocarbons.

In another aspect, the present invention relates to a system for fluid containment released from a pipeline. The system includes an elongate sealed vault adapted for housing a pipeline therein and constructed with fluid impervious side walls and a fluid impervious lower barrier. The system also includes at least one of a bore pit and an above-ground containment system for containing a predetermined amount of fluid released from the pipeline.

In another aspect, the present invention relates to a method of creating a containment system adapted for containing at least a predetermined volume of fluid released from a pipeline disposed therein. The method includes the steps of excavating a trench in a ground area for housing at least a portion of the containment system, sealing select features that may exist in the excavated trench, sealing side walls with a liquid impervious material, and sealing a floor of the trench with a liquid impervious material, thereby forming a lower barrier. The method also includes the steps of applying a bonding agent to the side walls for securing the side walls to the subsequently formed lower barrier, applying a sealant for providing additional sealing between the side walls and the lower barrier, providing a bedding material for support of a pipeline disposed within the trench, placing the pipeline within the trench atop the bedding material, and filling at least a portion of the trench with select backfill.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a side elevational view of the sealed trench design of the present invention illustrating a proposed pipeline therein and various construction aspects thereof;

FIG. 2 is an end elevational view of the sealed trench construction of FIG. 1 illustrating further aspects of construction of the present invention, and in particular the walls and floor;

FIG. 2A is a detailed view of a lower corner of the trench construction of FIG. 2;

FIG. 2B is a detailed view of an upper corner of the trench construction of FIG. 2;

FIG. 3 is a side elevational schematic representation of a length of pipeline utilizing a bore pit and a profile thereof;

FIG. 4 is an end view of the bore pit and trench system shown in FIG. 3;

FIG. 5 is a top view of the bore pit and trench system shown in FIG. 3;

FIG. 6 is a side elevational view illustrating a trench plug and a berm, as well as a sump pipe extending into the trench;

FIG. 7 is an end elevational view of the pipeline trench system and method of construction of the present invention illustrating the utilization of berms on opposite sides of the trench as well as other aspects of the construction thereof;

FIG. 8 is a top plan view of one aspect of the pipeline trench system and method of construction of the present invention incorporating a rainwater drainage system and trench plug;

FIG. 9 is a side plan view of the rainwater drainage system of FIG. 8;

FIG. 10 is a perspective view of the above ground containment area;

FIG. 11 is a perspective view of an alternate embodiment of an above ground containment area and rainwater drainage system; and

FIG. 12 is a flow diagram illustrating a method of constructing a trench system in accordance with embodiments of the present invention.

### DETAILED DESCRIPTION

It has been found that the trench system of the present invention can minimize exposure of the earthen region below and above a pipeline to pipeline spills. In that regard, the invention includes several aspects. The pipeline, in some instances, is encased in a pipeline trench comprising an elongate sealed vault (typically on the order of four feet wide and eight feet deep) to prevent leakage into the surrounding area. The trench system may also include bore pits (typically on the order of eight feet wide and 25-30 feet deep as shown in certain embodiments) at specific areas along the pipeline in flow communication with the pipeline trench for containing large amounts of leakage flowing from the pipeline trench. For instance, if a leak occurs along the pipeline, the leaking fluid flows into the sealed vault. The sealed vault acts as a conduit to direct the fluid to the lowest elevation area (e.g., a bore pit). The bore pit is capable of containing a relatively large amount of leakage relative to the same length of the sealed vault.

Depending on the topology and geology of the surrounding area, subsurface containment, such as a bore pit, may not be an optimal solution. As such, an above-ground containment area may also be used. In an above-ground containment implementation, berms or diked areas are utilized to contain spillage into specified areas. Therefore, any leakage from the pipeline fills the sealed vault, and when the sealed vault can no longer contain the spill, the fluid percolates up to the surface. The fluid at the surface is directed and pooled by the berms to prevent seepage into the surrounding area. Above-ground containment areas work well in rolling terrain where gravity assists the pooling and flow of fluids. A variety of arrangements of the sealed vault, bore pits, and above-ground containment area may be utilized to suit the terrain including flow valves for allowing the flow of water from the berms but not the flow of select fluids such as those containing hydrocarbons which can damage the environment.

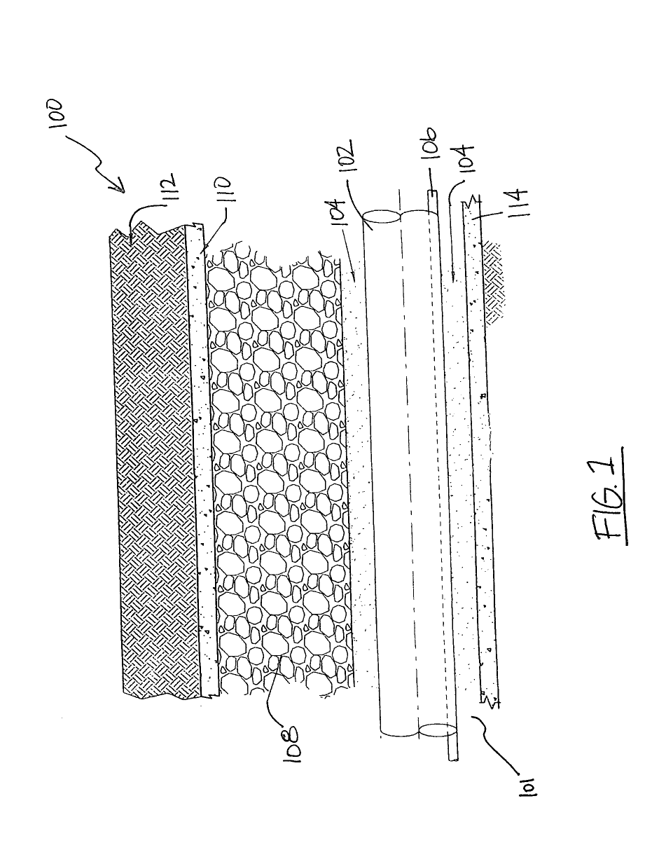

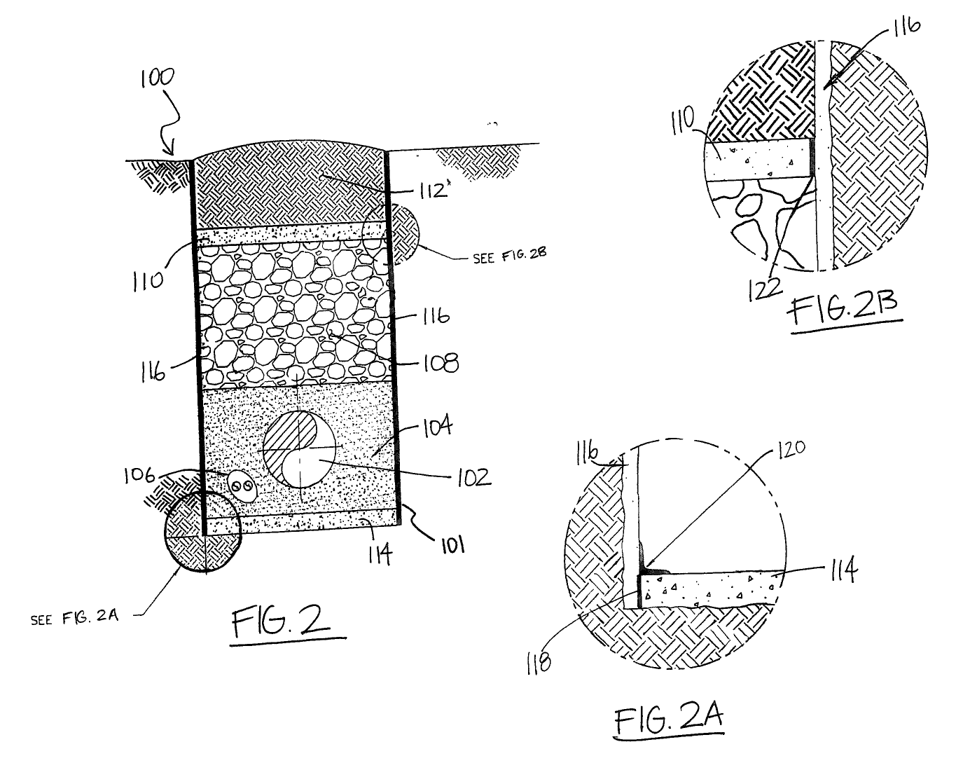

Referring now to the drawings, FIG. 1 illustrates a side elevational view of a trench system 100 of the present invention illustrating a proposed pipeline 102 therein and various construction aspects thereof. In the preferred embodiment, a sealed vault 101 of the trench system 100 is on the order of four feet wide and eight feet deep, however, other sizes of trench systems 100 may be implemented depending on the topography and geology of the surrounding area. The construction aspects include a select bedding 104 disposed beneath the pipe 102, a leak detection conduit 106 adjacent the pipe 102 (seen more clearly in FIG. 2), select bedding 104 above the pipe 102, and select backfill 108 atop the bedding 104 atop the pipe 102. The leak detection conduit 106 provides a means of placing a sensing cable capable of direct detection of a hydrocarbon material via direct contact of the cable by any leaked hydrocarbon substance in the sealed vault 101. At various intervals along the pipeline 102, a junction box may be placed at or near ground level above the pipeline 102. The junction box provides means for monitoring and/or testing, and/or replacement of the leak detection cables and circuits. In the preferred embodiment, a power conduit and a sensor conduit exit the junction box and travel down to the pipeline 102. The sensor conduit and the power conduit may be adjacent the pipeline 102 for sensing released hydrocarbons by direct contact. The conduits may be made of simple polyvinyl chloride (PVC) pipe. The power conduit is a solid wall design and the sensor conduit is made of “well screen” pipe, i.e., the pipe has minute slots cut into it to allow liquid to contact the leak detecting cable, but the slots are fine enough to keep sand and gravel out of the conduit. Tyco Thermal Controls of Menlo Park, Calif. manufactures conduit that is suitable for the power conduit and the sensor conduit.

Cathodic protection by impressed current relies on current from an outside power source being impressed on the pipeline 102 by using a ground bed and a power source to prevent galvanic corrosion of the pipeline 102 by moisture and electrolytes in the earth or soils around the pipeline 102. The backfill 108 and bedding 104 contain sufficient latent amounts of moisture as to provide the required current conduction path in order for the cathodic protection system to perform as required. The present invention does not use metal to form the trench system 100 or sealed vault 101 in order to allow the impressed current to pass through the sealed vault 101. Although the preferred embodiment utilizes impressed current for providing cathodic protection, other methods or systems of cathodic protection may be utilized in accordance with embodiments of the present invention.

The backfill 108 and bedding 104 are selected and graded to provide a high permeability fill with an interstitial void space capable of liquid capture and containment. In the preferred embodiment, the bedding 104 includes pea-size gravel and the select backfill 108 includes crushed and graded limestone with a porosity of the backfill interstitial space exceeding 40%. An upper barrier 110, typically made of concrete, is placed thereover, and the remaining portion of the trench is filled with compacted backfill forming a ditch crown 112. The backfill utilized in forming the ditch crown 112 is typically low permeability material which serves to inhibit the infiltration of rainwater into the trench system 100. The ditch crown 112 is shaped to prevent the rainwater from accumulating in the vicinity of the trench system 100.

In the preferred embodiment, the upper barrier 110 is four inches thick and dyed red, however, other thicknesses and dyes may be used in accordance with the aspects of the present invention. The upper barrier 110 is dyed red in order to alert third parties that might excavate in the pipeline right-of-way to the presence of a manmade structure below. In addition to the upper barrier 110, a lower barrier 114, also typically of concrete, provides an impermeable floor to prevent liquids transported through the pipeline 102 from leaking into an area below the pipeline 102.

Referring now to FIG. 2, there is shown an end elevational view of the sealed vault 101 of FIG. 1 illustrating further aspects of construction of the present invention. The side walls 116, the lower barrier 114, and the upper barrier 110 are sealed to form the sealed vault 110 that houses the pipeline 102. The trench is excavated and any features (e.g., fissures, voids, etc.) along the side walls are identified for possible attention. When necessary, the features are filled to reduce the likelihood that leakage from the pipeline 102 may permeate the side walls 116 and enter any such feature. By sealing the features, a high degree of sealing protection is achieved in the trench.

For example, in some geographies, varying degrees of secondary dissolution form a honeycomb or vugular porosity in a somewhat random pattern throughout the strata, thereby potentially penetrating side and bottom portions of the trench. The vugular porosity often functions as a recharge feature that carries groundwater eventually feeding an aquifer or other body of water. Therefore, it may be necessary to seal all such features to prevent any leakage from mixing with groundwater. In the preferred embodiment, large features of the trench are filled with rock and spot cemented prior to applying shotcrete to the side walls 116 in order to provide a fluid seal and a firm foundation for the adhesion of the shotcrete. The features in the trench may also be sealed or filled by utilizing grout, gravel, cobbles, etc. depending upon the size, configuration and orientation of the void or fissure. In addition, various other pipelines, such as storm drains, may cross the path of the pipeline 102 and sealed vault 101. In these cases, the joints of the storm drain are grouted and the exterior of the storm drain is sealed with shotcrete.

In the preferred embodiment, the side walls 116 are formed of shotcrete which adheres to the sides of the trench. Shotcrete is a mixture of aggregate, cement, glass fibers, and water with other additives that is sprayed into place under high pressure with a select quantity of moisture in the mixture. This application allows the shotcrete to be sprayed on the side walls 116 rather than poured in place using forms. The shotcrete may be applied as a wet mix or a dry mix. The dry mix system transfers a dry mix of aggregate and cement through a hose where water is added at the nozzle. The wet mix system pumps a low slump concrete through a hose where air is added at the nozzle. The dry mix system is commonly known as “gunite”. To increase the strength of the side walls 116, the shotcrete mixture may be applied with a relatively low moisture content via the dry mix system, although the wet mix system may be used without departing from the present invention. The side walls 116 are formed prior to the lower barrier 114 in the preferred embodiment in order to facilitate the sealing between the side walls 116 and the lower barrier 114.

As seen more clearly in FIG. 2A, the lower barrier 114 is disposed against the shotcrete-coated side walls 116 of the trench system 100 with a bonding agent 118 disposed therebetween. The bonding agent 118 is placed on the side walls 116 to further facilitate the bonding between the lower barrier 114 and the side walls 116. The bonding agent 118 may be an epoxy adhesive capable of accommodating movement within the trench. For example, a bonding agent such as “Sikadur 32 Hi Mod” has been found to be effective.

To effect further sealing integrity of the trench, a spray-applied polyurethane joint seal 120 is disposed along the side walls 116 and lower barrier 114 of the trench, after installation of the lower barrier 114, particularly along both side walls 116 extending outwardly therealong. The joint seal 120 may be sprayed anywhere along the length of the side walls 116, however, in the preferred embodiment, the majority of the joint seal 120 is sprayed in the lower corners of the trench system 100 and feathered out onto the side walls 116 and the lower barrier 114 about ten inches. At the joint of the side walls 116 and lower barrier 114, the thickness of the joint seal 120 is approximately between the range of 90 to 125 mils, i.e., 1 mil= 1/1000^{th} of an inch, however other thicknesses may be utilized. The joint seal 120 is feathered out to a thickness in the range of 40 to 90 mils on the side walls 116 and the lower barrier 114. By feathering out the joint seal 120 and varying the thickness, a durable seal with high adhesion is obtained. If the trench system 100 ever were to experience movement due to settling and shifting of the surrounding area, when utilizing the feathering technique, the joint seal 120 maintains adhesion to the concrete during movement without pulling loose from the side walls 116 and the lower barrier 114.

As shown in more detail in FIG. 2B, to seal the upper portion of the trench system 100, in some instances the upper barrier 112 is bonded to the side walls 116 of the trench system 100 with a bonding agent 122. For example, sealing the upper portion or the trench system 100 may prove valuable on approach to bore pits to prevent upward percolation of leakage from the pipeline trehnch. The bonding agent 122 may be similar to the bonding agent 118 applied at the lower portion of the side walls 116. After the lower portion of the sealed vault 101 has been properly sealed, backfill 108 is loaded into the sealed vault 101 to a predetermined height and the bonding agent 122 is applied to the side walls 116. The upper barrier 110 is then poured and adheres to the side walls 116 to prevent seepage of rainwater into the sealed vault 101 as well as seepage of fluid from the pipeline 102 into the surrounding area. The use of a bonding agent 122 in this location may vary in different parts of the trench system 100 as the likelihood of hydrostatic pressure from fluid collection varies.

As previously described, it is not necessary for all locations to include an upper barrier 110. In some areas an above-ground containment region may be desired, in which case an upper barrier 110 would not exist. In the above-ground containment region, the upper barrier 110 is not formed so that leaking fluid may flow to the surface for above-ground containment and later recovery.

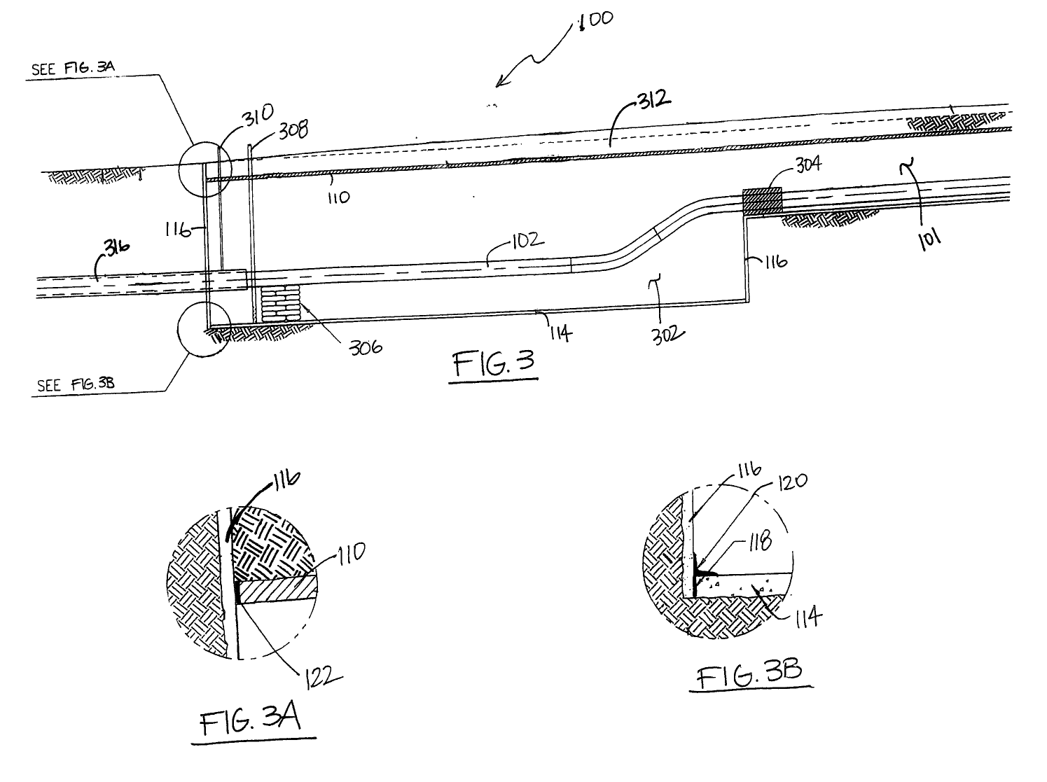

Referring now to FIG. 3, there is shown a trench system 100 including a bore pit 302 which may be utilized in the construction of the trench system 100 of the present invention. Bore pits 302 may include backfill, however, the backfill is eliminated in FIG. 3 for clarity. In certain instances, the elevation of the pipeline 102 is varied to accommodate geographical aspects, such as roads and the like. When utilized for crossing under a roadway, railway, or similar feature, a steel casing pipe 316 may be utilized to facilitate installing the pipeline 102 under the roadway. As previously mentioned, bore pits 302 are utilized to construct a bore for extending the pipeline at locations where surface excavation is impractical or undesirable. In some instances the bore pits 302 may be on the order of 25-30 feet deep, however, other depths may be utilized depending on the terrain encountered. The bore pit 302 may be sealed off by a partial or full trench plug 304. The trench plug 304, whether partial or full, is typically formed of cement, however, other materials that are not substantially permeable to liquid may be utilized. The trench plug 304 prevents pipeline 102 fluid from leaking to other areas. The bore pit 302 also provides a region adapted for accumulation of any pipeline spill that may occur. The bore pit 302 may be filled with backfill or bedding in a manner similar to that of the sealed vault 101 shown in FIGS. 1 and 2. The bore pit 302 may house one or more supports 306 to bolster up the pipeline 102. A drain pipe 308 and a vent pipe 310 may also be included in the trench system 100 of the present invention. The drain pipe 308 provides a means for inspection and removal of fluid. The vent pipe 310 is attached to each end of the casing pipe 316 below a road bore. The utility of the vent pipe 316 is to allow monitoring of the interstitial space between the pipeline 102 and the casing pipe 316 for the presence of an leaked select fluid.

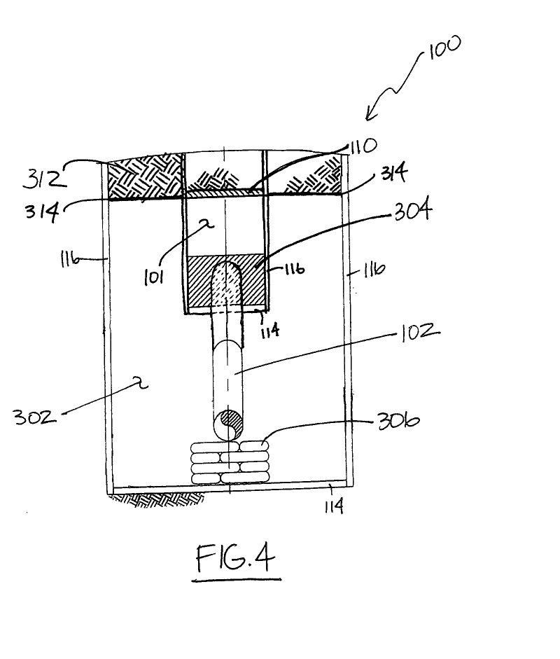

The upper barrier 110 may not extend the entire width of the bore pit 302 (shown in FIG. 4). A layer of top soil 312 may form a barrier that, due to appropriate packing and/or grading, will divert and/or absorb water in order to inhibit substantial infiltration of the water into the bore pit 302, which is filled with backfill, as described herein.

As illustrated in FIGS. 3A and 3B, the side walls 116, lower barrier 114, and upper barrier 110 may be sealed as set forth above with respect to FIGS. 2A and 2B. In the embodiment shown, the bore pit 302 includes a partial upper barrier 110 for preventing third party damage. However, it is possible to utilize a bore pit 302 without an upper barrier 110 so that the fluid flows into an above-ground containment area.

FIG. 4 illustrates an end view of the bore pit 302 and trench system 100 of an embodiment of the present invention. As shown, the sealed vault 101 includes an upper barrier 110 and a lower barrier 114. The sealed vault 101 is also partially sealed from the bore pit 302 with the trench plug 304. The pipeline 102 leaves the sealed vault 101 and descends into the bore pit 302. The pipeline is supported by supports 306 and the interior of the bore pit 302 may be filled with bedding and backfill (not shown). The sealed vault 101 is topped with a ditch crown 112 for preventing rainwater from pooling above the trench system 100. The bore pit 302 may not include an upper barrier 110 that extends the entire width of the bore pit 302. Instead, a geotextile cloth 314 may be placed over the backfill and top soil 312 is positioned on the geotextile cloth 314. The geotextile cloth 314 prevents the top soil 312 from migrating into the backfill and reducing the capacity of the bore pit 302. As previously mentioned, the top soil 312 is disposed to absorb water or is packed sufficiently to prevent substantial amounts of water from infiltrating into the bore pit 302.

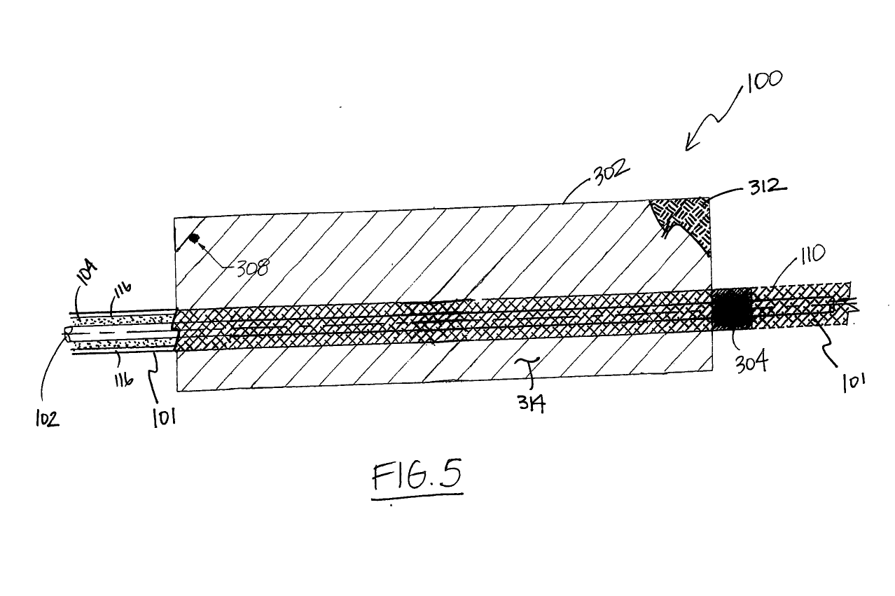

FIG. 5 illustrates a top plan view of the bore pit 302 and the construction thereof. The pipeline 102 travels through a sealed vault 101, into a bore pit 302, and to another sealed vault 101. As shown, the upper barrier 110 spans the entire width of the sealed vaults 101, but does not span the entire width of the bore pit 302. The geotextile cloth 314 and the top soil 312 are implemented for reducing the infiltration of water into the bore pit 302. Fluid leaking from the pipeline 102 housed within the sealed vault 101 may flow into the bore pit 302 for containment. The drain pipe 308 is utilized to monitor the fluid level and may also be used to remove the leaking fluid or groundwater that has seeped into the bore pit 302. The trench plug 304 creates a seal that prevents leakage flowing into the bore pit 302 from traveling further down the trench system 100 into, for example, another sealed vault 101.

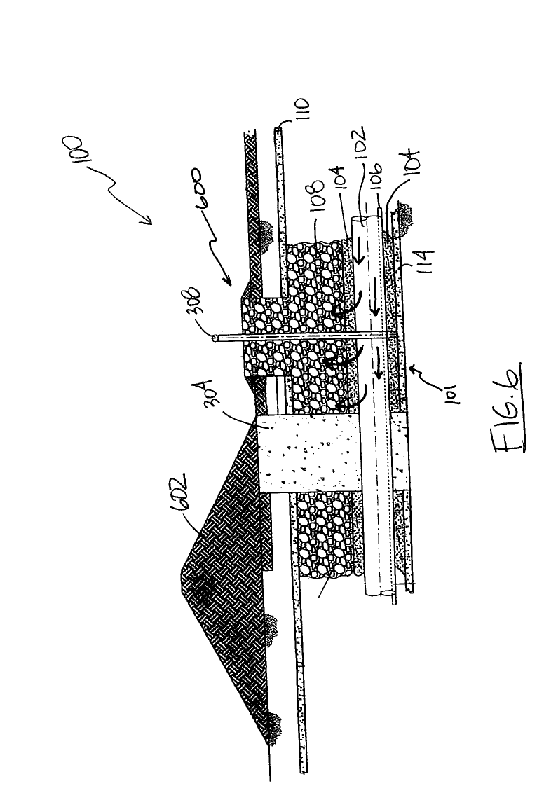

Referring now to FIG. 6, there is shown a side elevational view of the trench system 100 utilizing an above-ground containment system 600 including berms 602 in accordance with one aspect of the present invention. In this particular embodiment, the above-ground containment system 600 is utilized in conjunction with a sealed vault 101. However, the above-ground containment system 600 may be utilized with a bore pit 302 or any other sub-surface means of transporting and/or containing fluid. The berm 602 is utilized for surface containment of any spill coming from the pipeline 102 that may be egressing through the sealed vault 101. Berms 602 are designed to direct overland flow of fluids from the pipeline 102 away from any environmentally sensitive areas or to contain the leakage until it can be pumped out. The berms 602 are also designed to route storm water and fluids from the pipeline away from environmentally sensitive areas in the circumstance that a leak occurs during a rain event. For example, if a pipeline leak occurs while the ground is also being saturated with rain, the berms 602 direct the rainwater and leakage to a containment area for later removal. The berms 602 may be strategically placed along specific portions of the pipeline 102 and/or along specific grades of the above-ground terrain. By design, the berms 602 are erosion-resistant and substantially impervious to fluid.

In the preferred embodiment, the berms 602 are constructed of impervious fill material that has a coefficient of permeability substantially near 0.0000001 cm/sec. The fill material constructing the berms 602 also exhibits a liquid limit of greater than around 30 and a plasticity index of greater than around 15. Greater than around 30% of the fill material of the berms 602 should, in one embodiment, pass a #200 mesh sieve. The compaction of the fill material of the berms 602 may be around 95% at optimum moisture or around 90% at moisture about 1% dry of optimum. In one embodiment, the fill material should pass a one inch sieve and should not contain rocks or stones that total more than around 10% by weight. Although the preferred embodiment utilizes fill material for the berms 602 with the above characteristics, other fill materials with different characteristics may be used as long as the fill material does not allow a significant amount of liquid to permeate through the berm 602 to the surrounding area.

As previously mentioned, an upper barrier 110 is not necessary in areas where above-ground containment systems 600 may be implemented. Therefore, a void is created in the upper barrier 110 to allow leaking fluid to permeate the backfill 108 and reach the surface. The fluid flows over the surface and is contained by berms 602 as shown.

The trench plug 304 is placed to prevent further passage of the flowing spill, as indicated by directional arrows. The drain pipe 308 may be used to remove either water, which might have infiltrated into the sealed vault 101, and/or spilled fluid which is contained therein.

If a leak occurs, then the liquid carried in the pipeline 102 begins to fill the area surrounding the pipeline 102. The backfill 108 provides the released liquid a conduit to migrate under the force of gravity towards the lowest elevation in the immediate vicinity of the release. The liquid flows through the backfill 108 in the direction of the lowest elevation unit it reaches static equilibrium or an impermeable barrier such as the trench plug 304. As the liquid reaches the trench plug 304 and is blocked from further passage down the sealed vault 101, the liquid begins to fill the sealed vault 101. As the level of the liquid rises in the sealed vault 101 to the elevation of the upper barrier 110, the liquid begins to migrate to the surface via the void in the upper barrier 110. The liquid flows or ponds as directed by berms 602 or other barriers to prevent the liquid from passing into the surrounding area.

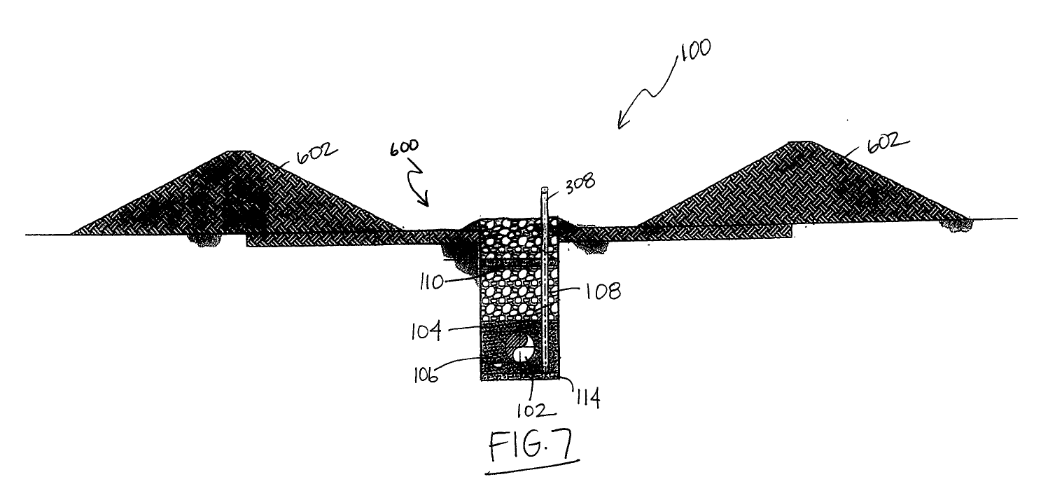

Referring now to FIG. 7, there is shown an end elevational view of the trench system 100 and above-ground containment system 600 as shown in FIG. 6. As illustrated above, liquid may flow up to the surface when a leak occurs. The berms 602 are disposed around sections of the sealed vault 101 adapted to allow flow therefrom, so that fluid leaking from the pipeline 102 is captured in the containment area and may be collected for subsequent retrieval.

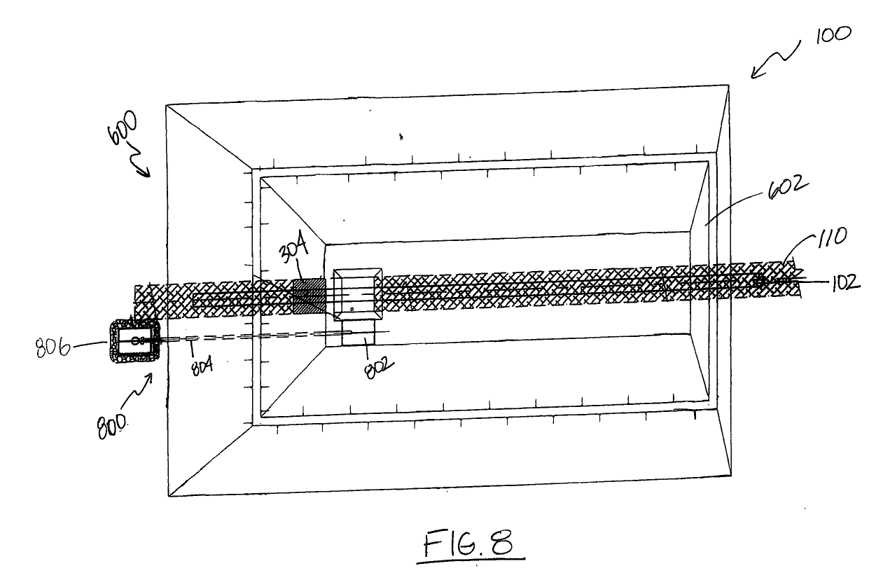

Referring now to FIG. 8, there is shown a top plan view of an above-ground containment system 600 and drainage system 800 constructed in accordance with the pipeline trench system 100 of the present invention. The surface containment system 600 includes a berm 602 to contain upon the surface any leak from the pipeline 102 that might migrate thereto. The trench plug 304 prevents leakage from continuing further along the trench, forcing the leakage to pool in the area of the sealed vault 101 protected by the berms 602. As previously mentioned, the trench plug 304 is positioned so that any spill flowing down the trench will be forced to migrate upwardly into the containment area through a gap in the upper barrier 110 designed for this purpose and previously illustrated in FIGS. 6 and 7.

The drainage system 800 includes a debris cage 802 located inside the containment area, a drainage pipe 804, and an exterior debris cage 806. The drainage system 800 allows collected rainwater to flow from the containment area, into inner debris cage 802, through the drainage pipe 804, and out into the surrounding area via the exterior debris cage 806 as described in greater detail below.

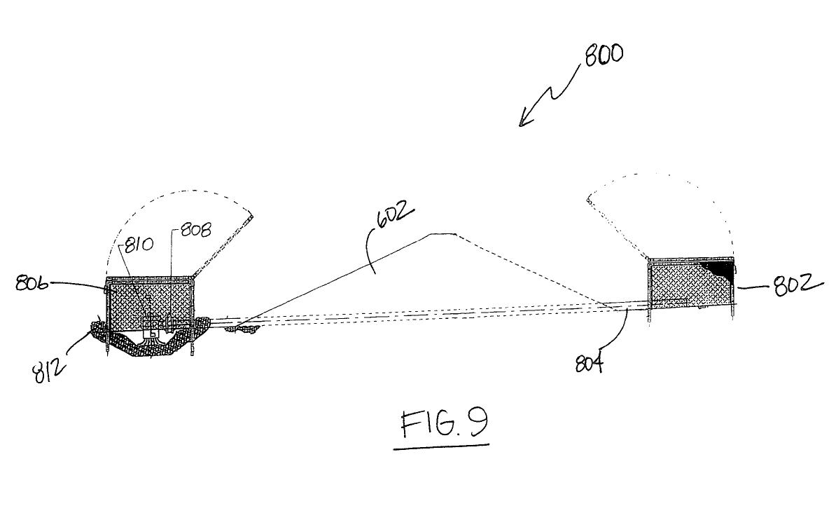

Referring now to FIG. 9, a side plan view of the rainwater drainage system 800 is illustrated. The inner and outer debris cages 802, 806 may be made of galvanized chain link fencing or other suitable material for preventing the drainage pipe 804 from becoming clogged. The outer debris cage 806 also serves as protection for the select fluid sensing valve 810 and butterfly valve 808 so as to discourage unauthorized tampering. In the preferred embodiment, the drainage pipe 804 is oriented at an angle so that rainwater may freely exit the containment area via gravity inducement. The drainage pipe 804 connects to the inner debris cage 802, exits the berm 602, and connects to the outer debris cage 806. Housed within the outer debris cage 806 is a butterfly valve 808 and a select fluid sensing valve 810. The select fluid sensing valve 810 allows drainage of rainwater from the containment area, but closes upon sensing select fluids, such as hydrocarbons. Thus the select fluid sensing valve 810 does not allow the passage of any liquid, product, or rainwater containing hydrocarbons to exit the containment area. In addition, the select fluid sensing valves 810 may be placed in various locations of the trench system 100 including the trench plug 304 to allow liquids not containing hydrocarbons to drain out of the trench that is sealed with the trench plug 304. The butterfly valve 808 acts as a manual override valve that may be activated by hand to prevent any liquid, whether including hydrocarbons or not, in the containment area from being released into the surrounding environment. In addition, if the select fluid sensing valve 810 does not close drip-tight, due to fouling or other circumstances, the butterfly valve 808 may be actuated to seal the drainage pipe 804 drip-tight.

Oriented under the outer debris cage 806 is a rock berm 812 wrapped with wire. The rock berm 812 aids in diverting rainwater flow away from the immediate area to prevent erosion around the drainage pipe 804 and to prevent clogging of the drainage pipe 804 orifice.

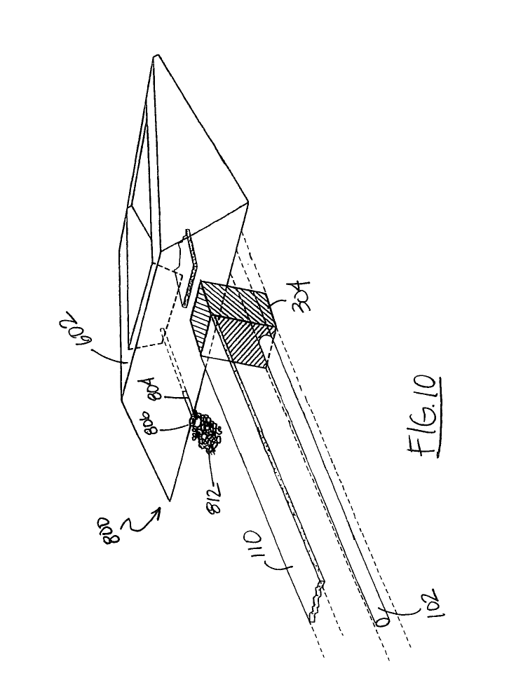

Referring now to FIG. 10, a perspective view of the above ground containment area and rainwater drainage system 800 is illustrated. As previously described, the trench plug 304 prevents further passage of a liquid leak to the surrounding environment. The pipeline 102 and trench system 100 may continue past the berm 602 and utilize various environmental protection techniques. Rainwater not contaminated with hydrocarbons exits the drainage pipe 804 and select fluid sensing valve 810 in order to prevent accumulation of rainwater in the containment area, thereby precluding a decrease in the available capacity of the containment area in the event of a pipeline 102 leak.

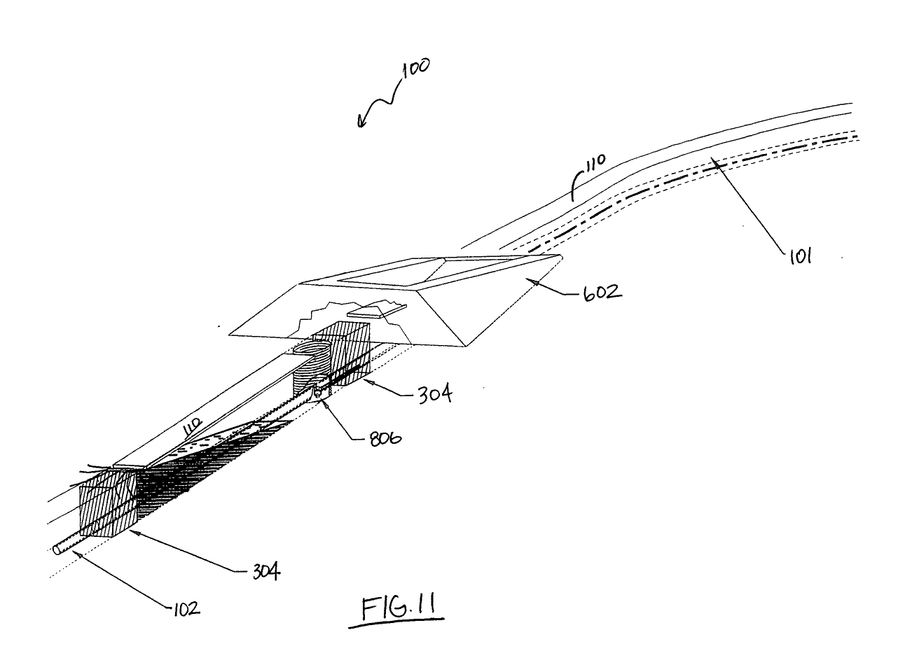

Referring now to FIG. 11, a perspective view of an alternate embodiment of an above ground containment area and rainwater drainage system 800 is illustrated. Similar to the system of FIG. 10, a sealed vault 101 surrounding the pipeline 102 underlies a berm system 602 for capturing leakage above ground. Exterior to the berms 602 is the trench plug 304 for preventing leakage from passing further down the trench system 100. A select fluid sensing valve 806 is located substantially near a lower portion of the sealed vault 101 and passes through the trench plug 304. The select fluid sensing valve 806 operates to allow water seeping into the sealed vault 101 to exit the trench system 100. The select fluid sensing valve 806 closes upon sensing select fluid, thereby preventing select fluid, such as hydrocarbons, from exiting the sealed vault 101.

In a similar manner, a select fluid sensing valve 806 may be placed at a lower portion of a sealed vault 101 or bore pit 302. The select fluid sensing valve 806 may connect to a drainage pipe and exit the sealed vault 101 or bore pit 302 and travel to ground level allowing water to exit the trench system 100 and release above ground.

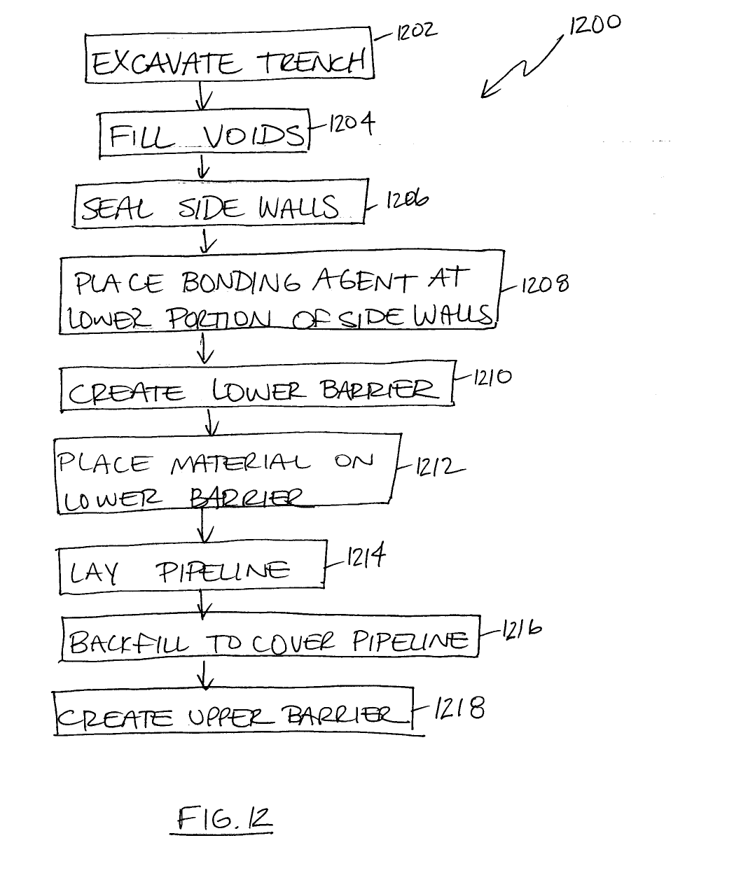

Referring now to FIGS. 2 and 12 in combination, a method 1200 of sealing a trench in accordance with embodiments of the present invention is illustrated. At step 1202, the trench is excavated and prepared for sealing. In some cases, once the trench is excavated, features such as fissures or voids of varying sizes and depths may exist. If such features exist, then at step 1204, the features are spot cemented or otherwise filled and sealed before sealing of the side walls 116 occurs. At step 1206, the side walls 116 are sealed with a liquid impervious material, such as shotcrete, to form a barrier that prevents liquid from seeping into surrounding sides of the trench. At step 1208, a bonding agent 118 is placed at a lower portion of the sealed side walls that contacts a lower barrier 114 that is formed at step 1210. The lower barrier 114 of the preferred embodiment is a poured cement floor, however, other implementations that provide adequate sealing may be utilized. A sealant 120, such as a polyurethane sealant, may be applied over at least a portion of the lower barrier 114 and the side walls 116 to provide additional sealing capabilities. At step 1212, material such as bedding 104 or other material is placed on the cured lower barrier 114. At step 1214, the pipeline 102 is laid on the bedding 104. At step 1216, backfill 108 is placed around and above the pipeline 102. This backfill 108 may have similar or different characteristics than the bedding 104 utilized at step 1212. At step 1218, an upper barrier 110 is placed on the backfill 108 filling the sealed vault 101. It will be understood, however, that certain portions of the sealed vault 101 may not have an upper barrier 110 in order to allow leakage from the pipeline 102 to percolate up to the surface for containment by berms 602 or other surface containment units as previously illustrated.

One skilled in the art would understand that aspects of the present invention need not be implemented throughout the entire run of the pipeline 102, from one endpoint to another. For example, many portions of an area through which the pipeline 102 passes may not require a sealed vault 101 due to the fact that the soils of the surrounding area may be relatively impermeable to liquid. Therefore, it is not necessary for the side walls 116 and lower barrier 114 of the sealed vault 101 to be coated with shotcrete and/or cement. Furthermore, one skilled in the art would readily appreciate that although the preferred embodiment illustrates side walls 116 and a lower barrier 114 that are substantially orthogonal, any configuration of trench and walls may be implemented without departing from the spirit and scope of the present invention.

The previous description is of a preferred embodiment for implementing the invention, and the scope of the invention should not necessarily be limited by this description. The scope of the present invention is instead defined by the following claims.

What is claimed is:

1. A pipeline trench vault for housing a pipeline and containing leaks occurring from the pipeline, the vault comprising:
side walls formed of a substantially fluid impervious material;
a lower barrier in engagement with the side walls, the lower barrier being formed of a substantially fluid impervious material; and
a first bonding agent adapted for bonding the side walls to the lower barrier.

2. The vault of claim 1, wherein the first bonding agent comprises an epoxy adhesive capable of accommodating any movement within the vault.

3. The vault of claim 1, further comprising:
a joint seal for providing a fluid impervious seal across a joint between the side walls and the lower barrier.

4. The vault of claim 3, wherein the width of the joint seal extending from the side walls across the lower barrier is on the order of ten inches.

5. The vault of claim 3, wherein the joint seal comprises a spray-applied polyurethane material.

6. The vault of claim 3, wherein the joint seal is applied so that the thickness of the joint seal is approximately between 90 and 125 mils at the joint and the thickness of the joint seal is approximately between 40 and 90 mils on the side walls and the lower barrier.

7. The vault of claim 1, further comprising:
bedding material for supporting the pipeline above the lower barrier.

8. The vault of claim 7, wherein the bedding material comprises pea-sized gravel.

9. The vault of claim 1, further comprising:
backfill adapted for positioning at least one of around and above the pipeline, the backfill permitting fluid within the vault to propagate through interstitial regions therebetween.

10. The vault of claim 9, wherein the backfill comprises crushed and graded limestone.

11. The vault of claim 9, wherein a porosity of the backfill includes an interstitial space exceeding 40%.

12. The vault of claim 1, further comprising:
an upper barrier extending across the side walls and above the backfill, the upper barrier for preventing fluid from exiting or entering the vault.

13. The vault of claim 12, wherein the upper barrier is formed of concrete.

14. The vault of claim 12, wherein the upper barrier is dyed red.

15. The vault of claim 12, further comprising: a ditch crown oriented above the upper barrier for preventing fluid from pooling above the vault.

16. The vault of claim 12, wherein the upper barrier is bonded to the side walls of the vault via a second bonding agent.

17. The vault of claim 16, wherein the second bonding agent and the first bonding agent are different.

18. The vault of claim 1, wherein the side walls and the lower barrier are substantially orthogonal.

19. The vault of claim 1, further comprising:
a leak detection conduit for detecting leaks of select fluid from the pipeline.

20. The vault of claim 1, further comprising:
a trench plug for preventing fluid from exiting a portion of the vault.

21. The vault of claim 1, wherein the side walls are formed of shotcrete.

22. The vault of claim 1, wherein the lower barrier is formed of concrete.

23. An above-ground containment system for containing select fluids released from a pipeline containment trench, the above-ground containment system comprising:
at least one berm for directing flow of the select fluids discharged from the pipeline containment;
a containment area for collecting the select fluids from the pipeline containment trench;
a drainage pipe for allowing water in the containment area to pass to a surrounding area; and
a select fluid sensing valve disposed in the drainage pipe for activating in the presence of the select fluids and substantially preventing the select fluids from passing therethrough.

24. The above-ground containment system of claim 23, further comprising:
a manual override valve for overriding the select fluid sensing valve, the manual override valve for preventing any fluid from exiting the containment area.

25. The above-ground containment system of claim 23, further comprising:
an inner debris cage for preventing debris from clogging the drainage pipe.

26. The above-ground containment system of claim 23, further comprising:
an outer debris cage for preventing debris from clogging the drainage pipe.

27. The above-ground containment system of claim 23, wherein the drainage pipe is oriented at an angle to aid flow of the fluid from the containment area to the surrounding area.

28. The above-ground containment system of claim 23, further comprising:
a rock berm for preventing erosion around the drainage pipe.

29. The above-ground containment system of claim 23, wherein the containment area is defined by at least one berm, and the select fluid is a fluid containing hydrocarbons.

30. A system for substantially containing pipeline fluid spills from a pipeline disposed therein, the system comprising:
an elongate pipeline trench vault adapted for housing the pipeline therein and constructed with fluid impervious side walls and a fluid impervious lower barrier and adapted for receiving a pipeline therein; and
at least one of a bore pit and an above-ground containment system in select flow communication with the vault for containing a predetermined amount of spilled fluid from the pipeline.

31. The system of claim 30, wherein the bore pit includes an enlarged trench area in flow communication for containing fluid from the pipeline in a subsurface arrangement.

32. The system of claim 31, wherein the bore pit comprises:
substantially vertical side walls, the side walls being formed of a substantially fluid impervious material;
a lower barrier in engagement with the side walls, the lower barrier being formed of a substantially fluid impervious material; and
a first bonding agent adapted for bonding the vertical side walls to the lower barrier.

33. The system of claim 32, wherein the first bonding agent comprises an epoxy adhesive capable of accommodating movement within the bore pit.

34. The system of claim 32, further comprising:
a joint seal for providing a fluid impervious seal across a joint between the side walls and the lower barrier.

35. The system of claim 34, wherein the width of the joint seal extending from the side walls across the lower barrier is on the order of ten inches.

36. The system of claim 34, wherein the joint seal comprises a spray-applied polyurethane material.

37. The system of claim 32, further comprising:
at least one support for supporting the pipeline above the lower barrier.

38. The system of claim 32, further comprising:
backfill adapted for positioning at least one of around and above the pipeline, the backfill permitting fluid within the bore pit to propagate through interstitial regions therebetween.

39. The system of claim 32, further comprising:
an upper barrier extending across the side walls and above the backfill, the upper barrier for preventing fluid from exiting or entering the bore pit.

40. The system of claim 39, further comprising:
a void in the upper barrier for allowing fluid to percolate to the surface above the bore pit, the surface above the bore pit surrounded by the above-ground containment system.

41. The system of claim 40, wherein the above-ground containment system comprises:
at least one berm for directing flow of the fluid from the pipeline;
a containment area for collecting the fluid from the pipeline;
a select fluid sensing valve for preventing select fluid from exiting the containment area; and
a drainage pipe for directing fluid from the containment area to a surrounding area.

42. The system of claim 41, further comprising:
an inner debris cage for preventing debris from clogging the drainage pipe.

43. The system of claim 41, further comprising:
an outer debris cage for preventing debris from clogging the drainage pipe.

44. The system of claim 41, wherein the drainage pipe is oriented at an angle to aid flow of the fluid from the containment area to the surrounding area.

45. The system of claim 41, wherein the containment area is defined by at least one berm.

46. The system of claim 41, wherein the select fluid sensing valve comprises a hydrocarbon sensing valve.

47. The system of claim 39, further comprising:
a ditch crown oriented above the upper barrier for preventing fluid from pooling above the bore pit.

48. The system of claim 30, further comprising:
a trench plug for preventing fluid from exiting a portion of the system.

49. The system of claim 30, wherein the bore pit is oriented at a predetermined location along the vault.

50. The system of claim 30, wherein the above-ground containment system is oriented at a predetermined location above the vault.

51. The system of claim 30, wherein the above-ground containment system is oriented at a predetermined location above the bore pit.

52. The system of claim 30, wherein the bore pit is remote from the vault.

53. The system of claim 30, wherein the above-ground containment system is remote from the vault.

54. A method of creating a containment system adapted for containing at least a predetermined volume of fluid released from a pipeline disposed therein, the method comprising the steps of:
excavating a trench in a ground area for housing at least a portion of the containment system;
sealing features that may exist in the excavated trench;
sealing side walls with a liquid impervious material;
sealing a floor of the trench with a liquid impervious material, thereby forming a lower barrier;
applying a bonding agent to the side walls for securing the side walls to the lower barrier;
applying a sealant for providing additional sealing between the side walls and the lower barrier;
providing a bedding material for support of a pipeline disposed within the trench;
placing the pipeline within the trench atop the bedding material; and
filling at least a portion of the trench with backfill.

55. The method of claim 54, further comprising the step of:
forming an upper barrier over the backfill for substantially preventing fluid from leaking into or out of the trench.

56. The method of claim 54, wherein the step of sealing the side walls comprises spraying shotcrete on side walls of the trench.

57. The method of claim 54, wherein the step of sealing a floor of the trench comprises pouring a cement layer to form the lower barrier.

58. The method of claim 54, wherein the step of applying a bonding agent comprises applying an epoxy adhesive at a lower portion of the side walls.

59. The method of claim 54, wherein the step of applying a sealant comprises spraying a polyurethane material so that the thickness of the sealant is approximately between 90 and 125 mils at a joint of the side walls and the lower barrier and the thickness of the sealant is approximately between 40 and 90 mils on the side walls and the lower barrier.

60. The method of claim 54, wherein the step of providing a bedding material comprises supplying pea-sized gravel.

61. The method of claim 54, wherein the step of filling at least a portion of the trench with backfill comprises filling at least a portion of the trench with crushed and graded limestone, wherein a porosity of the crushed and graded limestone includes an interstitial space exceeding 40%.

62. The method of claim 54, further comprising the step of:
placing a leak detection conduit in the trench for sensing whether a leak has occurred.

63. The method of claim 54, further comprising the step of:
forming a trench plug along a portion of the trench for preventing fluid from passing therethrough.

64. The method of claim 54, further comprising the step of:
forming a bore pit, the bore pit being an enlarged subsurface containment area.

65. The method of claim 54, further comprising the step of:
forming an above-ground containment area along a predetermined portion of the trench.

66. The method of claim 65, further comprising the steps of:
forming at least one berm for directing flow of the fluid from the pipeline;
forming a containment area for collecting the fluid from the pipeline;
providing a select fluid sensing valve for preventing select fluid from exiting the containment area; and
forming a drainage pipe for directing fluid from the containment area to another area.

67. The method of claim 66, wherein the step of providing a select fluid sensing valve comprises the step of providing a hydrocarbon sensing valve.

68. The method of claim 66, further comprising the step of:
providing a manual override valve for overriding the select fluid sensing valve.

69. The method of claim 66, wherein the step of forming a drainage pipe comprises forming the drainage pipe at an angle to aid flow of the fluid from the containment area to another area.

70. The method of claim 66, wherein the step of forming a containment area comprises forming a network of berms to contain the fluid.

71. The method of claim 66, further comprising the step of:
providing an inner debris cage for preventing debris from clogging the drainage pipe.

72. The method of claim 66, further comprising the step of:
forming a rock berm for preventing erosion around the drainage pipe.
